(19) United States
(12) Patent Application Publication
(10) Pub. No.: US 2009/0161494 A1
(43) Pub. Date: Jun. 25, 2009

(54) Modeling Method for Evaluating Unit Delay Time of Inverter and Apparatus Thereof

(76) Inventor: Sang Hun KWAK, Seoul (KR)

Correspondence Address: THE LAW OFFICES OF ANDREW D. FORTNEY, PH.D., P.C., 401 W FALLBROOK AVE STE 204, FRESNO, CA, 93711-5835, US

(21) Appl. No.: 12/340,289

(22) Filed: Dec. 19, 2008

(30) Foreign Application Priority Data
Dec. 24, 2007 (KR) 10-2007-0136536

(51) Int. Cl. G04F 10/00

(52) U.S. Cl. 368/113

(57) ABSTRACT

A modeling method for evaluating a unit delay time of an inverter and an apparatus thereof are disclosed. The present modeling method includes deriving a model for a plurality of inverters, including a channel length, a channel width and a gate electrode resistance as variables in the model; measuring a delay time by inputting variations in the variables; and determining a unit delay time for one inverter by dividing the delay time by the number of inverters.

The present application claims priority under 35 U.S.C. § 119(e) of Korean Patent Application No. 10-2007-0136536 (filed on Dec. 24, 2007), which is hereby incorporated by reference in its entirety.

### BACKGROUND

### Description of the Related Art

Embodiments of the invention relate to a modeling method for evaluating a unit delay time of an inverter and an apparatus thereof.

In order to evaluate the performance of a transistor, the unit delay time of an inverter including the transistor is generally evaluated.

FIG. 1 is a view showing an inverter circuit for measuring a unit delay time of an inverter.

Referring to FIG. 1, a ring oscillator including an odd number of inverters is used for measuring the unit delay time of an inverter in the ring.

For example, the unit delay time of an inverter is determined as a value that is obtained by applying an input signal to an input terminal, measuring a period through an output signal inverted on a measurement location, and then dividing the measured period by the number of inverters.

Meanwhile, in modeling for estimating a unit delay time of an inverter, actual size of a channel length and a channel width of a transistor included in an inverter actually manufactured is input and simulated based on the input actual size. The resistance of a polysilicon sheet is not reflected in the model, on the assumption that the resistance of the polysilicon sheet used as a gate electrode of a transistor is very small.

However, when a silicide process is not applied to the gate electrode, the resistance of the poly sheet increases so that the resistance of the polysilicon sheet affects the accuracy of the simulation result.

FIG. 2 is a view showing a portion of a unit inverter of a ring oscillator.

Referring to FIG. 2, in the unit inverter, a portion indicated by (A) represents a channel length, a portion indicated by (B) represents a channel width, and a length from (C) to (D) represents a length of a gate electrode 13. Contacts 11 in a source region are disposed on one side of the gate electrode 13, and contacts 12 in a drain region are disposed on the other side of the gate electrode 13.

Voltage is applied to the gate electrode 13 from a contact to the gate electrode. When a silicide process is not applied to the gate electrode, the resistance of the gate electrode 13 (that is, the resistance of the polysilicon sheet) increases to cause a voltage drop depending on the distance spaced from the contact to the gate electrode 14.

FIG. 3 is a diagram showing resistance and capacitance of a gate electrode, depending on the distance that the gate electrode is spaced from the contact to the gate electrode, and FIG. 4 is a diagram mathematically simplifying the resistance and capacitance components of FIG. 3.

Through the mathematical calculation, the gate electrode 13 has an equivalent resistance (Req) value and an equivalent capacitance (Ceq) value, wherein the Req value is approximately ½ of entire resistance of the gate electrode 13.

The resistance of the gate electrode affects the simulation results as described above. In the related art, the resistance of the gate electrode 13 has not been considered when simulating the unit delay time of the inverter, causing a problem in that the accuracy of the model and of estimates made using the model are less than optimal.

### SUMMARY OF THE INVENTION

Embodiments of the disclosure provide a modeling method for evaluating a unit delay time of an inverter and an apparatus thereof.

Embodiments of the disclosure provide a method for evaluating more precisely a unit delay time of an inverter and an apparatus thereof, by considering the resistance of a gate electrode.

A modeling method for evaluating a unit delay time of an inverter according to embodiments of the disclosure includes deriving a model for a plurality of inverters including a channel length, a channel width and a gate electrode resistance of a transistor as variables; measuring a delay time by inputting variations into the variables; and determining a unit delay time for one inverter by dividing the delay time by the number of inverters.

A modeling apparatus for evaluating a unit delay time of an inverter according to embodiments of the disclosure includes a computer readable medium storing commands to simulate the unit delay time of the inverter, wherein the commands set models and variables for a plurality of inverters, wherein the variables include a channel length, a channel width, and a gate electrode resistance of a transistor, and the commands include determining a delay time of a chain or ring of serially-connected inverters as variations are input into the variables, and determining a unit delay time of the inverter by dividing the delay time by the number of inverters in the chain or ring.

### BRIEF DESCRIPTION OF THE DRAWINGS

FIG. 1 is a diagram showing an exemplary inverter circuit for measuring a unit delay time of an inverter;

FIG. 2 is a diagram showing an exemplary portion of a unit inverter of a ring oscillator.

FIG. 3 is a diagram showing exemplary resistance and capacitance components of a gate electrode depending on the distance that the gate electrode is spaced from a contact for the gate electrode.

FIG. 4 is a diagram showing how to mathematically simplify the resistance and capacitance components of the gate electrode of FIG. 3.

FIG. 5 is a diagram showing an exemplary apparatus for measuring a unit delay time of an inverter according to embodiments of the invention; and

FIG. 6 is a view showing exemplary results from Table 1, Table 2 and Table 3.

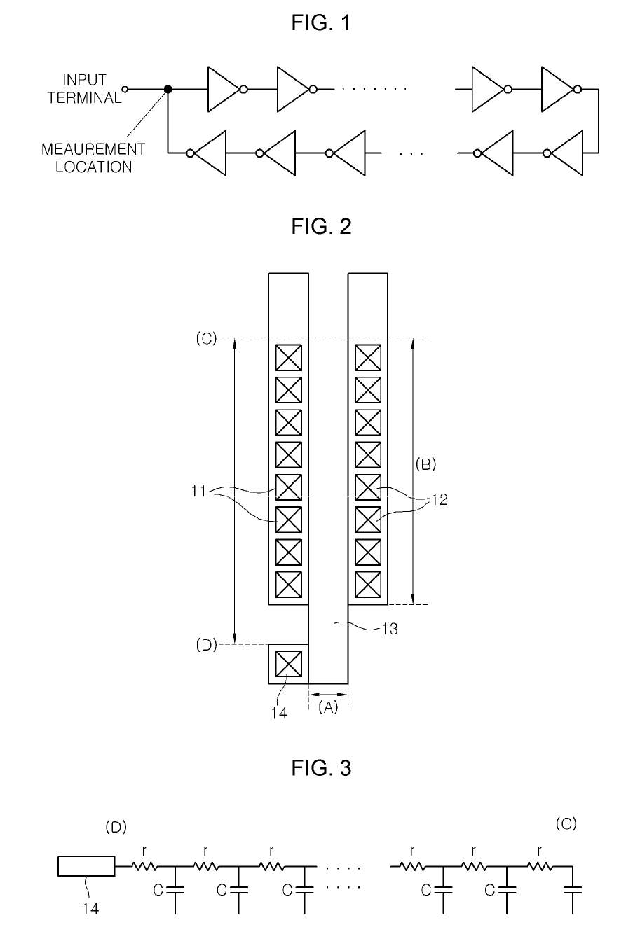

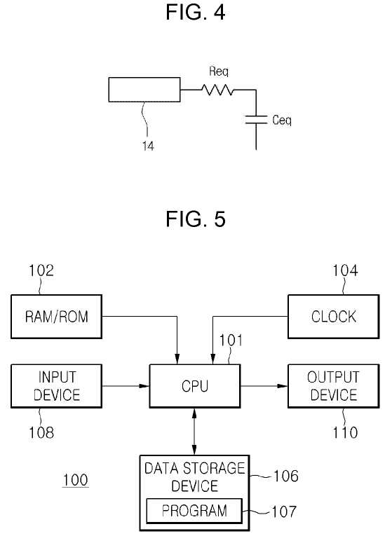

### DETAILED DESCRIPTION OF THE EMBODIMENTS

Hereinafter, a modeling method for evaluating a unit delay time of an inverter and an apparatus thereof according to embodiments of the disclosure will be described in detail with reference to the accompanying drawings.

FIG. 5 is a view showing an exemplary apparatus for measuring a unit delay time of an inverter according to embodiments of the invention.

Referring to FIG. 5, a modeling apparatus 100 is disclosed as a hardware configuration computer system. The modeling apparatus 100 operates so as to receive program commands and user inputs, and to output results corresponding to the commands and outputs. The modeling apparatus 100 has a central processing unit (CPU) 101, which may be a general-purpose microprocessor, such as a microprocessor manufactured by Intel Corp. The CPU 101 is operably connected to a RAM/ROM 102, a clock 104, a data storage device 106, an input device 108, and an output device 110.

The random access memory (RAM), in particular, may include a number of memory modules having a sufficient storage capacity for storing processing commands used by the CPU 101 during the operation of the modeling apparatus 100. The optional read only memory (ROM) may comprise a permanent (non-volatile) memory medium capable of storing commands performed by the CPU 101 during the startup routine of the modeling apparatus 100. Other functions of the RAM/ROM 102 will be apparent to those skilled in the art.

The clock 104 may be a built-in component of the CPU 101. In any case, the CPU 101 prescribes the speed of the clock that synchronizes and carries out timing of the communications between the hardware components of the modeling apparatus 100. Other functions of the clock 104 will be apparent to those skilled in the art.

The input device 108 may comprise one or more generally well-known devices, used to communicate information with the modeling apparatus 100 through other computer system or user input commands. Therefore, the input device 108 may include a keyboard, a mouse, a scanner, a voice recognition unit, a serial or parallel port, an optional network card for connecting to a network or for otherwise receiving data, or other communication cards. The input device 108 operates so that the user can input the commands and values according to the present invention.

The output device 110 may comprise one or more generally well-known devices used by the modeling apparatus 100 in order to communicate to the user of the modeling apparatus 100 the results of processing the input commands in accordance with the values (e.g., of the variables in the model). Therefore, the output device 110 may include a display monitor, a voice recognition unit, a speaker or other audio unit, a printer, a serial or parallel port, an optional network card for connecting to a network or for otherwise transmitting data, or other communication cards. The output device 110 operates so that the user can receive the results of processing the commands and values according to the present invention.

The data storage device 106 may comprise an internal and/or external large-capacity memory for storing computer data, and the storage capacity may be more than 1, 10 or 100 gigabytes. In particular, the data storage device 106 stores one or more application programs such as an operating system of Microsoft Corporation and a program 107 (e.g., an integrated circuit simulating program). Therefore, the data storage device 106 may comprise a hard disk drive, a CD-ROM disk and a reader/writer, a DVD disk and a reader/writer, a ZIP disk drive, an optional different computer readable medium that can store processing commands in a read-only or read-write format, etc. Other functions of the data storage device 106 and its usable devices will be apparent to those skilled in the art.

The program 107 includes a plurality of processing commands allowing the modeling apparatus 100 to receive the inputs (e.g., data and/or information) and to evaluate the unit delay time of the inverter. In one embodiment, the program 107 may allow the unit delay time of the inverter to be estimated, modeled and/or verified based on a SPICE program.

For example, in the program 107, a ring oscillator including a plurality of inverters with variables including applied voltage and channel width and channel length of a transistor is modeled. Also, the variables include the gate electrode resistance, as described herein. And, through a Monte Carlo method, a simulation is carried out, wherein a delay time is output and/or determined by generating random numbers and inputting variations into the respective variables. An inverter unit delay time is determined by dividing the delay time by the number of inverters.

In other words, the program 107 operates having the simulation variables including the resistance Rpoly of the gate electrode. In one example, a model is derived as shown in Equation 1 below.

$$Rpoly = RpolyO \times \frac{Leff}{Weff} \times \frac{1}{2 a} \qquad [ Equation 1 ]$$

In the Equation 1, Rpoly represents the resistance of the gate electrode, Rpoly0 represents a surface resistance of the gate electrode, Leff represents one of an effective channel width or gate electrode length, Weff represents the other of the gate electrode width or effective channel length, and “a” represents a correction-coefficient. Also, the Leff and Weff may be described or defined as W-2dW and L-2dl, respectively. Here, 2dW and 2dL refer to deviations of the channel length and channel width at opposite sides of the gate electrode based on a central portion (e.g., from the center) of the gate electrode, respectively. Viewed statistically, 2dW and 2dL may be replaced with 2^{1/2}dW and 2^{1/2}dL or any value between 2^{1/2}dW and 2dW or 2^{1/2}dL and 2dL. Also, “a” refers to a correction-coefficient reflecting an equivalent capacitance (Ceq) value, that is a capacitance component of the gate electrode, and supplementing the deviation according to various channel widths. The parameter or variable “a” is obtained by carrying out a plurality of experiments on a plurality of ring oscillators having various channel widths, and an optimal correction-coefficient may be selected according to the Leff value.

In other words, the modeling apparatus according to embodiments of the disclosure includes a program 107 capable of simulating the unit delay time of the inverter, and the program 107 reflects and/or includes the resistance of the gate electrode (e.g., as a component in at least one modeling equation).

The below Table 1 shows the results of including the resistance of the gate electrode versus not including the resistance of the gate electrode in simulating the unit delay time of the inverter. The correction-coefficient a is set as 1.

TABLE 1

| | Unit delay time before | Unit delay time after | Difference |
|---|---|---|---|
| Vcc | resistance is applied [pS] | resistance is applied [pS] | (%) |
| 2.7 | 55.29 | 74.12 | 34.1% |
| 3 | 47.90 | 66.28 | 38.4% |
| 3.3 | 43.24 | 60.55 | 40.0% |

Table 2 below shows the results of including the resistance of the gate electrode and not including the resistance of the gate electrode in simulating the unit delay time of the inverter when setting the correction-coefficient a as 2.

TABLE 2

| | Unit delay time before | Unit delay time after | Difference |
|---|---|---|---|
| Vcc | resistance is applied [pS] | resistance is applied [pS] | (%) |
| 2.7 | 55.29 | 64.23 | 16.2% |
| 3 | 47.90 | 56.56 | 18.1% |
| 3.3 | 43.24 | 51.44 | 19.0% |

Table 3 below shows the results of including the resistance of a silicided gate electrode and not including the resistance of the silicided gate electrode in simulating the unit delay time of the inverter. The correction-coefficient a is set as 1.

TABLE 3

| | Unit delay time before | Unit delay time after | Difference |
|---|---|---|---|
| Vcc | resistance is applied [pS] | resistance is applied [pS] | (%) |
| 2.7 | 55.29 | 55.43 | 0.3% |
| 3 | 47.90 | 48.22 | 0.7% |
| 3.3 | 43.24 | 43.33 | 0.2% |

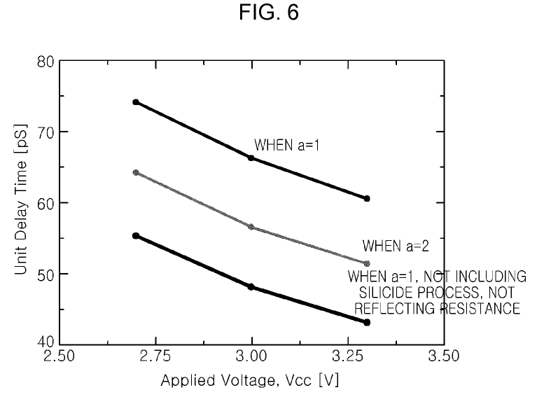

FIG. 6 is a graph showing the results of Table 1, Table 2 and Table 3.

As can be seen from the Table 3, there is little difference in the unit delay time of the inverter as a function of the applied voltage Vcc when comparing the simulated unit delay time of the inverter before the resistance is applied to the simulated unit delay time of the inverter after the resistance is applied, in the case of a silicided gate electrode. Therefore, the graphs for this case overlap in FIG. 6.

Meanwhile, it can be appreciated that there are differences between the simulated unit delay time of the inverter before the resistance is applied and the simulated unit delay time of the inverter after the resistance is applied in the case of a non-silicided gate electrode. Also, it can be appreciated that the simulation results differ according to the correction-coefficient a.

As described above, in the simulation for evaluating the unit delay time of the inverter, the resistance of the gate electrode is considered so that the unit delay time of the inverter can be evaluated more exactly, thereby making it possible to evaluate the characteristics of a transistor more exactly.

Any reference in this specification to “one embodiment,” “an embodiment,” “exemplary embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for evaluating a unit delay time of an inverter, including:
deriving a model for a plurality of inverters including a channel length, a channel width and a gate electrode resistance of a transistor as variables;
measuring a delay time by inputting variations into the variables; and
determining a unit delay time for one inverter by dividing the delay time by the number of inverters.

2. The method according to claim 1, wherein the gate electrode resistance is represented by the equation:
$$Rpoly = RpolyO \times \frac{Leff}{Weff} \times \frac{1}{2 a}$$
where Rpoly represents the gate electrode resistance, Rpoly0 represents a surface resistance of the gate electrode, Leff represents an effective channel width, Weff represents an effective channel length, and a represents a correction-coefficient.

3. The method according to claim 2, wherein the correction-coefficient a is a value obtained by carrying out a plurality of experiments on a plurality of ring oscillators having various channel widths.

4. An apparatus for evaluating a unit delay time of an inverter, including:
a computer readable medium storing commands for estimating the unit delay time of the inverter,
wherein the commands set models and variables for a plurality of inverters,
wherein the variables include a channel length, a channel width, and a gate electrode resistance of a transistor, and the commands include determining a delay time of a chain or ring of serially-connected inverters as variations are input into the variables, and determining a unit delay time of the inverter by dividing the delay time by the number of inverters in the chain or ring.

5. The apparatus according to claim 4, wherein the gate electrode resistance is represented by the equation:
$$Rpoly = RpolyO \times \frac{Leff}{Weff} \times \frac{1}{2 a}$$
where Rpoly represents the gate electrode resistance, Rpoly0 represents a surface resistance of the gate electrode, Leff represents an effective channel width, Weff represents an effective channel length, and a represents a correction-coefficient.

6. The apparatus according to claim 5, wherein the correction-coefficient a is a value obtained by carrying out a plurality of experiments on a plurality of ring oscillators having various channel widths.
